(19) United States
(12) Patent Application Publication
(10) Pub. No.: US 2023/0029941 A1
(43) Pub. Date: Feb. 2, 2023

(54) SYSTEM AND METHOD OF TRANSFERRING HEAT FROM THE GROUND

(71) Applicant: Lloyd ELDER, Edmonton (CA)

(72) Inventor: Lloyd ELDER, Edmonton (CA)

(21) Appl. No.: 17/876,777

(22) Filed: Jul. 29, 2022

Related U.S. Application Data
(60) Provisional application No. 63/388,765, filed on Jul. 13, 2022.
(60) Provisional application No. 63/243,882, filed on Sep. 14, 2021.
(60) Provisional application No. 63/236,005, filed on Aug. 23, 2021.
(60) Provisional application No. 63/227,102, filed on Jul. 29, 2021.

(51) Int. Cl. F22B 1/16; F01K 7/16; F01K 15/00; E21B 41/00

(52) U.S. Cl. CPC F22B 1/165; F01K 7/16; F01K 15/00; E21B 41/0085

(57) ABSTRACT

A system and method of transferring heat from the ground is described. At least one heat pipe is provided that has a hollow interior, a heat output end, and a heat input end. The heat output end is positioned higher that the heat input end. The hollow interior contains a working fluid that transfers heat from the input end to the output end. The working fluid is a liquid at a first temperature and a gas at a second temperature where the second temperature is greater than the first temperature. The working fluid becomes a gas as it is heated at the heat input end and returns to a liquid at the heat output end of the pipe when the heat is transferred out of the heat pipe. The heat transferred from the heat output end of the heat pipe is captured for future use.

### FIELD OF THE DISCLOSURE

The present application relates generally to a system and method of transferring heat from the ground. More particularly, it relates to the use of heat pipes to transfer heat from the ground.

### BACKGROUND

This section provides background information to facilitate a better understanding of the various aspects of the invention. It should be understood that the statements in this section of this document are to be read in this light, and not as admissions of prior art.

In an attempt to curb the increase in greenhouse gas emission, alternative energy sources have become more popular. Solar, wind, and conventional geothermal technologies have been created in an attempt to reduce the use of hydrocarbons; however, these technologies are not yet advanced enough or cost effective enough to replace hydrocarbons. Each of these technologies suffer from disadvantages that make them unsuitable in many situations.

### BRIEF SUMMARY

There is provided a method of transferring heat from the ground. At least one heat pipe is provided. Each of the at least one heat pipe has a hollow tube that has a heat output end and a heat input end. The heat output end is positioned higher than the heat input end. The hollow tube contains a working fluid that transfers heat from the heat input end to the heat output end. The working fluid is a liquid at a first temperature and a gas a second temperature where the second temperature is greater than the first temperature. The working fluid becomes a gas as it is heated at the heat input end of the heat pipe. The working fluid rises upwards to the heat output end of the heat pipe. The working fluid becomes a liquid as the heat is transferred out of the heat pipe at the heat output end. The working fluid flows back to the heat input end as a liquid. The at least one heat pipe is positioned in a hole in the ground such that the heat input end of the heat pipe is adjacent a heat source. It will be understood by a person skilled in the art that the heat source can simply be a location in the ground that is warmer than the surface or may be a heated aquifer, tectonic plate, lava flow, or any other heat source available underground. Heat from the heat output end of the heat pipe is captured for future use.

In one embodiment, the hole in the ground is an orphaned well.

In another embodiment, the hole in the ground is a carbon dioxide underground compressed gas sequestration site.

In one embodiment, the captured heat from the heat output end of the heat pipe is used to generate electricity by heating a steam chamber that creates steam to operate a steam turbine. The steam turbine produces electricity.

In one embodiment, the captured heat from the heat output end of the heat pipe is used to generate electricity using a thermoelectric generator where the captured heat is used on a hot side of the thermoelectric generator.

In one embodiment, at least two heat pipes are positioned in end to end relation with each other such that the heat input end of a first heat pipe is positioned adjacent a heat source. The heat output end of the first heat pipe is adjacent the heat input end of a second heat pipe such that heat is transferred upwards between adjacent heat pipes.

In one embodiment, the heat pipe is a sealed tubular shaft.

In one embodiment, the heat pipe is a coiled tube.

There is also provided a method of transferring heat from the ground. A vacuum sealed plasma drilled wellbore that has a melted rock wall is provided. The vacuum sealed plasma drilled wellbore having a hollow interior. A heat output end is positioned at a top of the vacuum sealed plasma drilled wellbore and a heat input end is positioned at a bottom of the vacuum sealed plasma drilled wellbore. The heat input end is positioned adjacent a heat source. The hollow interior contains a working fluid. The working fluid transfers heat from the heat input end to the heat output end. The working fluid is a liquid at a first temperature and a gas at a second temperature where the second temperature is greater than the first temperature. The working fluid becomes a gas as it is heated at the heat input end of the heat pipe. The working fluid rises upwards to the heat output end of the heat pipe. The working fluid becomes a liquid as the heat is transferred out of the heat pipe at the heat output end. The working fluid flows back to the heat input end as a liquid. The heat from the heat output end of the vacuum sealed plasma drilled wellbore is captured for future use.

In one embodiment, the captured heat from the heat output end of the heat pipe is used to generate electricity by heating a steam chamber that creates steam to operate a steam turbine. The steam turbine produces electricity.

In one embodiment, the captured heat from the heat output end of the heat pipe is used to generate electricity using a thermoelectric generator where the captured heat is used on a hot side of the thermoelectric generator.

A system of transferring heat from the ground to create electricity utilizes at least one heat pipe. Each of the at least one heat pipes is made of a hollow tube that has a heat output end and a heat input end. The heat output end is positioned higher than the heat input end. The hollow tube contains a working fluid. The working fluid transfers heat from the heat input end to the heat output end. The working fluid is a liquid at a first temperature and a gas at a second temperature where the second temperature is greater than the first temperature. The working fluid becomes a gas as it is heated at the heat input end of the heat pipe. The working fluid rises upwards to the heat output end of the heat pipe. The working fluid becomes a liquid as the heat is transferred out of the heat pipe at the heat output end. The working fluid flows back to the heat input end as a liquid. The at least one heat pipe is positioned in the ground such that the heat input end is positioned adjacent a heat source. It will be understood by a person skilled in the art that the heat source can simply be a location in the ground that is warmer than the surface or may be a heated aquifer, tectonic plate, source rock, lava flow, or any other heat source available underground. An electricity generator is positioned adjacent the heat output end of the heat pipe such that heat from the heat output end is used to create electricity.

In one embodiment, the heat pipe is a sealed tubular shaft.

In one embodiment, the heat pipe is a coiled tube.

In one embodiment, the heat pipe is a vacuum sealed plasma drilled wellbore having a melted rock wall.

In one embodiment, the electricity generator is a steam chamber that is positioned adjacent the heat output end of the heat pipe. The steam chamber is heated by the heat pipe to create a steam. The steam runs a turbine to create electricity.

In one embodiment, the electricity generator is a thermoelectric generator is which heat from the heat output is introduced to a hot side of the thermoelectric generator.

In one embodiment, at least two heat pipes are positioned in end to end relation with each other such that the heat input end of a first heat pipe is positioned adjacent a heat source. The heat output end of the first heat pipe is adjacent the heat input end of a second heat pipe such that heat is transferred upwards between adjacent heat pipes.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a side elevation view, in section, of a heat pipe.

FIG. 2 is a schematic view of a daisy chain of heat pipes in a wellbore in communication with a thermoelectric generator.

FIG. 3 is a schematic view of a coiled tube heat pipe in a wellbore in communication with a thermoelectric generator.

FIG. 4 is a schematic view of a vacuum sealed plasma drilled wellbore in communication with a thermoelectric generator.

FIG. 5 is a schematic view of a daisy chain of heat pipes in a wellbore in communication with a steam chamber and steam turbine.

FIG. 6 is a side elevation view of an embodiment of a daisy chained heat pipes with couplers.

### DETAILED DESCRIPTION OF THE PREFERRED EMBODIMENTS

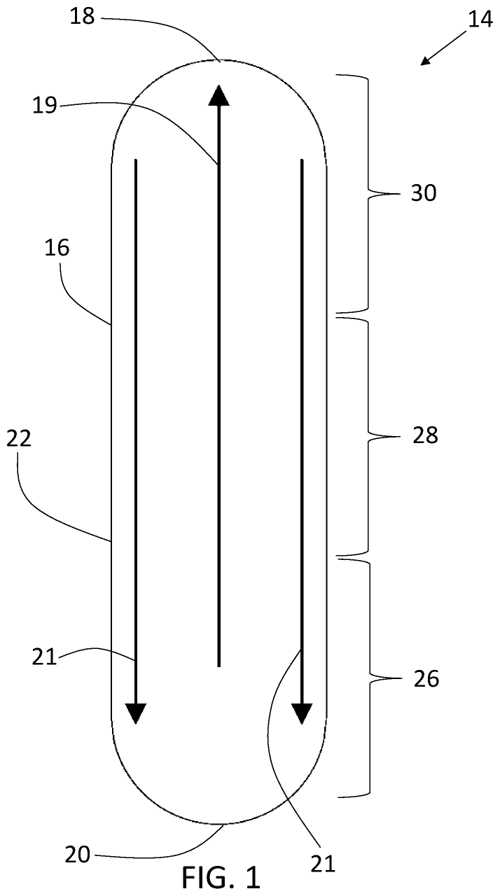

A system and method of transferring heat from the ground will now be described with reference to FIG. 1 through FIG. 6.

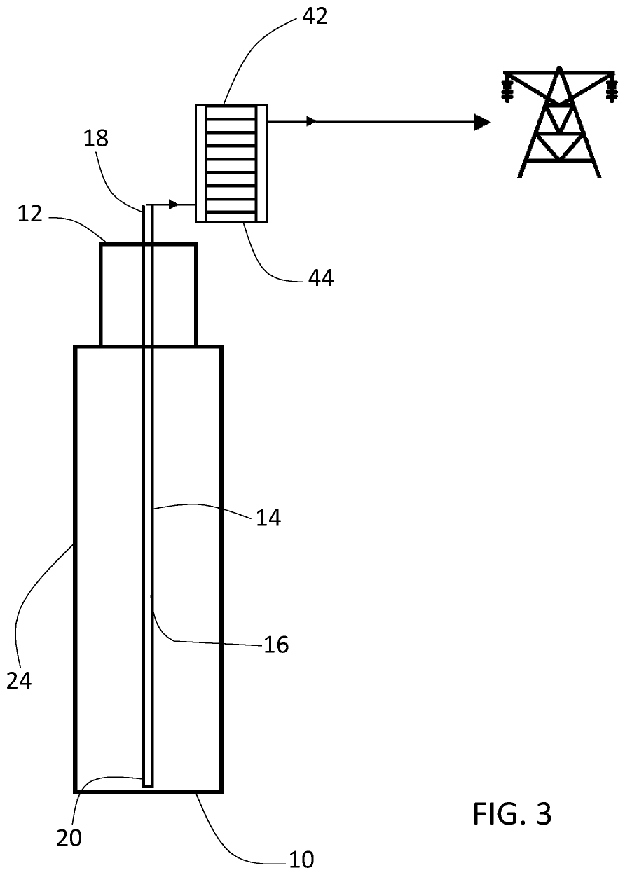

Referring to FIG. 3, heat is transferable from the ground 10 to the surface 12 using a heat pipe 14. Heat pipes are self-contained vacuum sealed tubes that may be used to transfer heat from one end to the other. When positioned in a vertical orientation, heat pipes are known as thermosyphons. Heat pipe 14 is a hollow tube 16 with a heat output end 18 and a heat input end 20. Heat output end 18 is positioned higher than heat input end 20. Hollow tube 16 contains a working fluid. Working fluid transfers heat from heat input end 20 to heat output end 18. Working fluid is a liquid at a first temperature and a gas at a second temperature. The second temperature is greater than the first temperature. The working fluid becomes a gas as it is heated at heat input end 20 of heat pipe 14. Once the working fluid is a gas, it rises upwards to heat output end 18 of heat pipe 14. At heat output end 18, heat is transferred out of heat pipe 14 and working fluid condenses to a liquid. The liquid working fluid flows back to heat input end 20. As can be seen in FIG. 1, working fluid in the gaseous phase rises through the center of hollow tube 16, identified by arrow 19 and condensed liquid working fluid flows down walls 22 of hollow tube, identified by arrows 21. Referring to FIG. 3, heat pipe 14 is positioned within a hole 24 in ground 10 such that heat input end 20 of heat pipe 14 is adjacent a heat source. Hole 24 may be a newly drilled wellbore, orphaned well, carbon dioxide underground compressed gas sequestration site, or any other suitable hole known to a person skilled in the art. It will also be understood by a person skilled in the art that heat source can simply be a location in ground 10 that is warmer than surface 12 or may be a heated aquifer, tectonic plate, source rock, lava flow, or any other heat source available underground. Heat is captured at heat output end 18 of heat pipe 14 for future use.

Heat pipes 14 may be a sealed tubular shaft, as shown in FIG. 1. In the embodiment shown in FIG. 3, heat pipe 14 is a coiled tube. Coiled tube can create a different wick, working fluid, pipe material, and overall design when compared to a sealed tubular shaft. Coiled tube can be customized for different depths within the earth. Bottom end of coiled tube forms evaporator end 26 of heat pipe 14 in wellbore 24.

Referring to FIG. 1, heat pipe 14 may be divided into three sections, the evaporator 26, the adiabatic section 28 and the condenser 30. Evaporator 26 is at heat input end 20 and includes a small volume of working fluid. Condenser 30 is at heat output end 18. Adiabatic section 28 is positioned between evaporator 26 and condenser 30. When heat is applied to heat input end 20, working fluid is heated and evaporates within evaporator 26. The fluid vapor quickly spreads to heat output end 18 of heat pipe 14 using pressure generated by the temperature difference. At heat output end 18, or condenser 30, the fluid vapor gives up its latent heat which is ejected to an external heat sink where it is captured for future use. The working fluid then returns to liquid form and returns to the heat input end 20 using capillary force. To aid in returning the working fluid to heat input end 20, walls 22 of heat pipe 14 act as a wick to encourage condensation and movement back to heat input end 20. Walls 22 of heat pipe 14 may be smooth or may have grooves or mesh-like qualities to improve wicking. Heat transfer using this method is extremely efficient. Heat pipes 14 are closed loop systems and are able to operate continuously and passively. This creates a reliable thermal management system. In addition, the transfer of heat from heat input end 20 to heat output end 18 is incredibly fast.

Heat pipes 14 may be made out of different materials, have different lengths and diameters, utilize different working fluids, have varying wick structures that help create capillary action within heat pipe 14, and have variations related to evaporator section 26, adiabatic section 28, and condenser section 30. Different combinations will result in different efficiency of heat travel and the amount of heat that can be transferred by heat pipe 14. As an example, heat pipe 14 may be made of molybdenum with a lithium working fluid. This specific design may allow operation at white-hot temperatures approaching 2200° F. Once heated, the lithium vaporizes and carries heat from heat input end 20 to heat output end 20. It will be understood by a person skilled in the art that heat pipes 14 may be made of any suitable material that allows for the transfer of heat, such as metals and other minerals. The material must have a melting point higher than the highest temperature the heat pipe may be heated to be effective. The working fluid must have a boiling point that allows for the evaporation and condensation cycle within heat pipe 14 to operate.

When wells no longer produce sufficient oil to be profitable, they become abandoned wells. These wells could be given a second purpose by placing heat pipes 14 downhole to transfer heat from the bottom of the wellbore to the surface 12. Each orphaned wells could be repurposed by inserting a heat pipe 14. Where bore fields of orphaned wells are present, the repurposed wellbores could become an interconnected grid of heat pipes 14. Repurposing wells can significantly reduce the cost of utilizing this technology since drilling is one of the most costly aspects of geothermal. Wells will not be limited to abandoned or orphaned wells, new wells that are drilled strategically and purpose fit for the heat pipe are also contemplated.

Carbon dioxide sequestration sites were developed to compress gas underground. These sites may be adapted for the purpose of collecting heat from the ground. These sites may be given a second purpose by heat pipes 14 into the sequestration underground site.

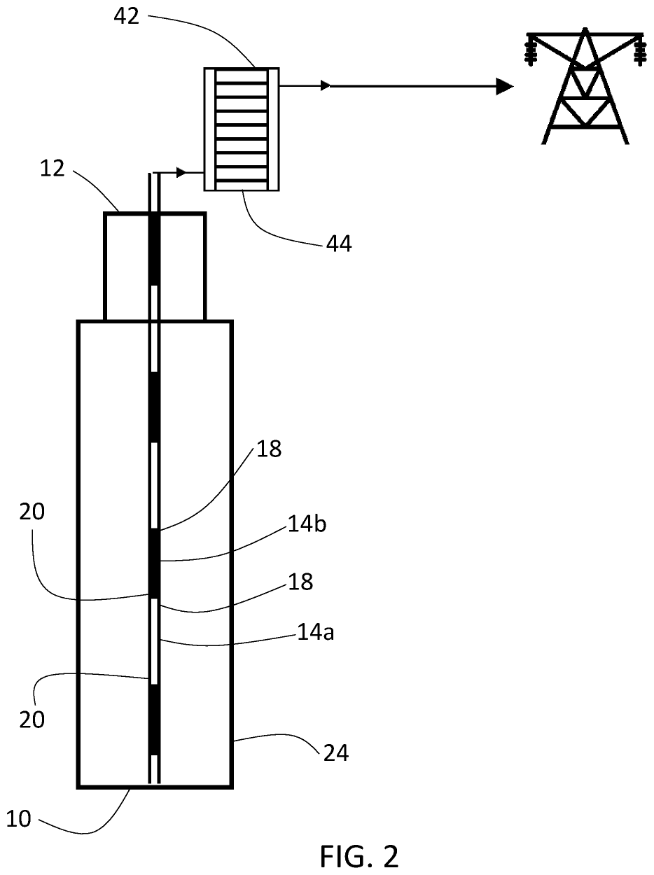

Referring to FIG. 2, in order to move heat from ground 10 to surface 12, a series of heat pipes 14 may be used. Placing a plurality of heat pipes 14 in end to end relation down a hole 24 can allow heat from the earth to be transferred quickly to the surface 12. Holes 24 can be wellbores, underground carbon dioxide sites, or any other suitable hole known to a person skilled in the art. Heat pipes 14 are placed in end to end relation such that heat output end 18 of a first adjacent heat pipe 14a is positioned adjacent heat input end 20 of a second adjacent heat pipe 14b. The number of heat pipes 14 used to create a “daisy chain” may vary depending on the depth of hole 24 and the length of each heat pipe 14. In this way, second adjacent heat pipe 14b acts as a heat sink to capture the heat from first adjacent heat pipe 14a. The number of heat pipes used will be dependent upon the length of the heat pipes and the depth of the hole. By adjusting heat pipes to allow for a different wick, working fluid, pipe material and overall design, a custom modular daisy chain may be created for use at different depths within the earth. Each heat pipe within the daisy chain may be different.

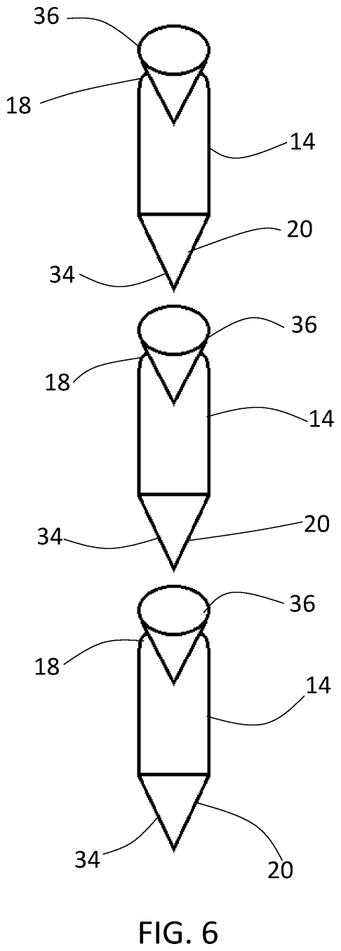

Referring to FIG. 6, a unique coupling between heat pipes may also be used to help limit or prevent heat loss during transfer which would result in a loss of efficiency and to assist in proper alignment of the daisy chained heat pipes 14. Different couplings may be used depending on the composition of heat pipes 14 being coupled. An example of a potential coupling is shown. In the embodiment shown, coupling utilizes a conical male end 34 being engageable within a corresponding female end 36 of an adjacent heat pipe. It will be understood by a person skilled in the art that different types of couplings may be used.

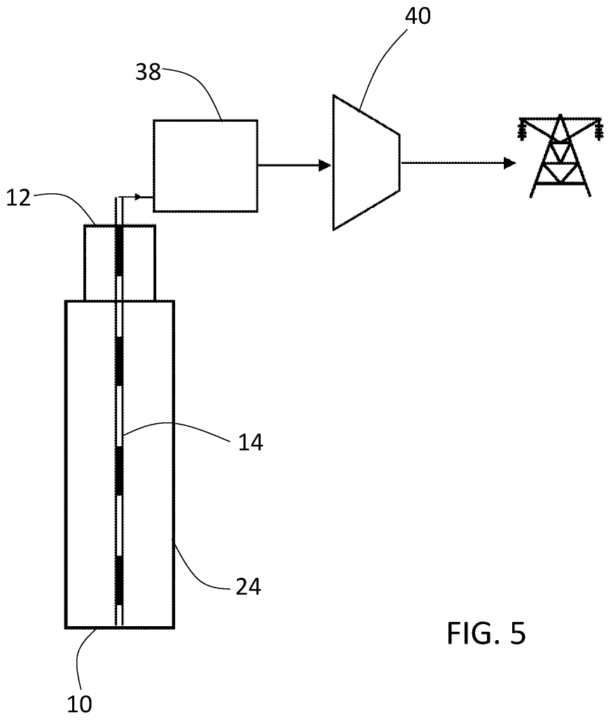

Captured heat from heat output end 18 of heat pipe 14 may be used to generate electricity. In the embodiment shown in FIG. 5, captured heat may be used to heat a steam chamber 38. Steam chamber 38 may be used to boil or flash boil a liquid, such as water, to create steam. Steam may be used to operate a steam turbine 40 that produces electricity. The produced electricity may be used immediately, stored in batteries, or directed to the local electric grid for use by others.

In the embodiment shown in FIG. 2 through FIG. 4, captured heat from heat output end 18 of heat pipe 14 is used to generate electricity using a thermoelectric generator 42 when the captured heat is used on a hot side 44 of thermoelectric generator 42.

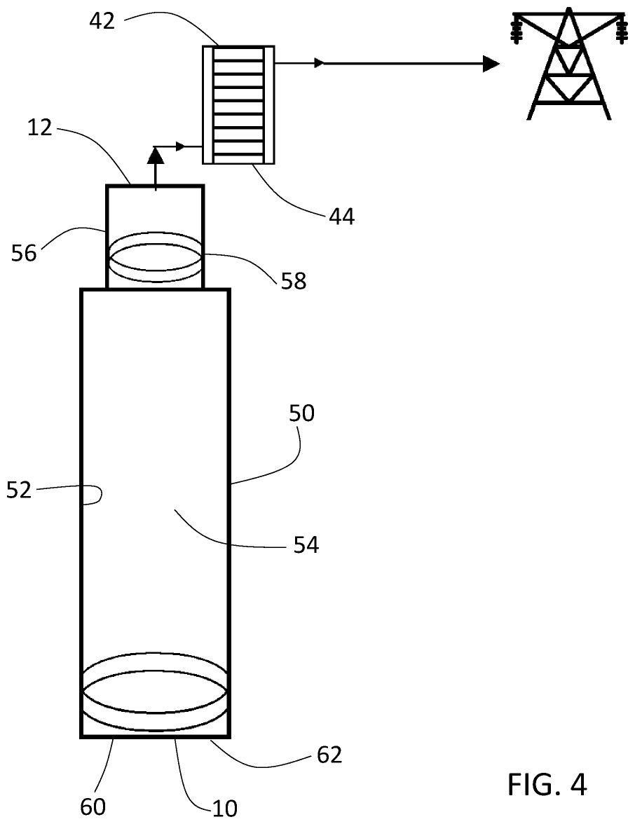

In the embodiment shown in FIG. 4, heat is transferable from the ground 10 to the surface 12 using a vacuum sealed plasma drilled wellbore 50 that has a melted rock wall 52. Vacuum sealed plasma drilled wellbore 50 has a hollow interior 54, a heat output end 56 positioned at a top 58 of vacuum sealed plasma drilled wellbore 50, and a heat input end 60 positioned at a bottom 62 of vacuum sealed plasma drilled wellbore 50. Heat input end 60 is positioned adjacent a heat source. It will be understood by a person skilled in the art that heat source 64 may be a location in ground 10 that is warmer than surface 12 or may be a heated aquifer, tectonic plate, source rock, lava flow, or any other heat source 64 available underground. Heat is captured at heat output end 56 of vacuum sealed plasma drilled wellbore 50 for future use. Hollow interior 54 contains a working fluid. Working fluid transfers heat from heat input end 60 to heat output end 56. Working fluid is a liquid at a first temperature and a gas at a second temperature where the second temperature is greater than the first temperature. The working fluid becomes a gas as it is heated at heat input end 60 of vacuum sealed plasma drilled wellbore. The working fluid rises upwards to heat output end 56. Working fluid becomes a liquid as the heat is transferred out of vacuum sealed plasma drilled wellbore 50 at heat output end 56. Working fluid flows back to heat input end 60 as a liquid. Heat is captured from heat output end 56 of vacuum sealed plasma drilled wellbore for future use.

Captured heat from heat output end 56 of vacuum sealed plasma drilled wellbore 50 may be used to generate electricity. In the embodiment shown in FIG. 5, captured heat may be used to heat a steam chamber 38. Steam chamber 38 may be used to boil or flash boil a liquid, such as water, to create steam. Steam may be used to operate a steam turbine 40 that produces electricity. The produced electricity may be used immediately, stored in batteries, or directed to the local electric grid for use by others.

In the embodiment shown in FIG. 4, captured heat from heat output end 56 of vacuum sealed plasma drilled wellbore 50is used to generate electricity using a thermoelectric generator 42 when the captured heat is used on a hot side 44 of thermoelectric generator 42.

A system for transferring heat from the ground to create electricity utilizes heat pipes in conjunction with an electricity generator. Heat pipes can be sealed tubular shafts, coiled tubes, or vacuum sealed plasma drilled wellbores with melted rock walls. Two or more heat pipes may be positioned in end to end relation with each other to allow for longer distances of heat transfer. The heat pipes are positioned in the ground. For sealed tubular shafts and coiled tubes, holes in the ground allow for easier installation. Holes may include freshly drilled wellbores, abandoned wells, underground carbon dioxide sites, or any other suitable hole known to a person skilled in the art. It will be understood by a person skilled in the art that tubular shafts and coiled tubes may be installed into the ground without previous drilled holes, however damage to the tubular shafts and coiled tubes may occur. Abandoned wells, underground carbon dioxide sites, or any other suitable hole known to a person skilled in the art may also be repurposed to a vacuum sealed plasma wellbore by using a plasma drill to create a rock well. Care should be taken to ensure safety if repurposing abandoned wells. Heat pipes are positioned in the ground such that the heat input end is positioned adjacent a heat source. An electricity generator is positioned adjacent heat output end of heat pipe such that heat from heat output end is used to create electricity.

Captured heat from heat output end of heat pipe may be used to generate electricity. In the embodiment shown in FIG. 5, captured heat may be used to heat a steam chamber 38. Steam chamber 38 may be used to boil or flash boil a liquid, such as water, to create steam. Steam may be used to operate a steam turbine 40 that produces electricity. The produced electricity may be used immediately, stored in batteries, or directed to the local electric grid for use by others.

In the embodiment shown in FIG. 2 through FIG. 4, captured heat from heat output end of heat pipe is used to generate electricity using a thermoelectric generator 42 when the captured heat is used on a hot side 44 of thermoelectric generator 42.

In the embodiment shown in FIG. 4, a plasma drilled wellbore can be used. Plasma drilled wellbores have melted rock walls and can be sealed to create a vacuum. Bottom end of plasma drilled wellbore forms the evaporator end of a thermosyphon. Heat from plasma drilled wellbore can be used to supply a hot side of a thermoelectric generator (TEG) to create electricity. A cold side of thermal electric generator may use heat pipes in a different configuration intended for cooling to help maximize the difference in temperature between hot side and cold side. Heat may also be used for other purposes and in other ways to create electricity.

Ultimately, the purpose of the daisy chained heat pipes, coiled tube heat pipes, and vacuum sealed plasma drilled wellbores are to move geothermal heat from ground 10 to surface 12. Heat will be sourced directly from the earth's geothermal gradient into heat pipes designed for that particular depth and temperature. One benefit of this system is that obtaining geothermal power requires no fuel, no pumps, and is, therefore, immune to fuel cost fluctuations. Geothermal power is cost-effective, reliable, sustainable, and environmentally friendly but has previously been limited to areas near tectonic plate boundaries.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. A method of transferring heat from the ground, comprising the steps of:
providing at least one heat pipe, each of the at least one heat pipe comprising a hollow tube having a heat output end and a heat input end, the heat output end being positioned higher than the heat input end, the hollow tube containing a working fluid, the working fluid transferring heat from the heat input end to the heat output end, the working fluid being a liquid at a first temperature and a gas at a second temperature where the second temperature is greater than the first temperature, the working fluid becoming a gas as it is heated at the heat input end of the heat pipe, the working fluid rising upwards to the heat output end of the heat pipe, the working fluid becoming a liquid as the heat is transferred out of the heat pipe at the heat output end, the working fluid flowing back to the heat input end as a liquid;
positioning the at least one heat pipe into a hole in the ground such that the heat input end of the heat pipe is adjacent a heat source;
capturing heat from the heat output end of the heat pipe.

2. The method of claim 1 wherein the hole in the ground is an orphaned well.

3. The method of claim 1 wherein the hole in the ground is a carbon dioxide underground compressed gas sequestration site.

4. The method of claim 1 wherein the captured heat from the heat output end of the heat pipe is used to generate electricity by heating a steam chamber that creates steam to operate a steam turbine, the steam turbine producing electricity.

5. The method of claim 1 wherein the captured heat from the heat output end of the heat pipe is used to generate electricity using a thermoelectric generator where the captured heat is used on a hot side of the thermoelectric generator.

6. The method of claim 1 wherein at least two heat pipes are positioned in end to end relation with each other such that the heat input end of a first heat pipe is positioned adjacent a heat source, and the heat output end of the first heat pipe is adjacent the heat input end of a second heat pipe such that heat is transferred upwards between adjacent heat pipes.

7. The method of claim 1 wherein the heat pipe is a sealed tubular shaft.

8. The method of claim 1 wherein the heat pipe is a coiled tube.

9. A method of transferring heat from the ground, comprising the steps of:
providing a vacuum sealed plasma drilled wellbore having a melted rock wall, the vacuum sealed plasma drilled wellbore having a hollow interior, a heat output end positioned at a top of the vacuum sealed plasma drilled wellbore and a heat input end positioned at a bottom of the vacuum sealed plasma drilled wellbore, the heat input end being positioned adjacent a heat source, the hollow interior containing a working fluid, the working fluid transferring heat from the heat input end to the heat output end, the working fluid being a liquid at a first temperature and a gas at a second temperature where the second temperature is greater than the first temperature, the working fluid becoming a gas as it is heated at the heat input end of the vacuum sealed plasma drilled wellbore, the working fluid rising upwards to the heat output end of the vacuum sealed plasma drilled wellbore, the working fluid becoming a liquid as the heat is transferred out of the vacuum sealed plasma drilled wellbore at the heat output end, the working fluid flowing back to the heat input end as a liquid; and
capturing heat from the heat output end of the vacuum sealed plasma drilled wellbore.

10. The method of claim 9 wherein the captured heat from the heat output end of the vacuum sealed plasma drilled wellbore is used to generate electricity by heating a steam chamber that creates steam to operate a steam turbine, the steam turbine producing electricity.

11. The method of claim 9 wherein the captured heat from the heat output end of the vacuum sealed plasma drilled wellbore is used to generate electricity using a thermoelectric generator where the captured heat is used on a hot side of the thermoelectric generator.

12. A system of transferring heat from the ground to create electricity, comprising:
at least one heat pipe, each of the at least one heat pipe comprising a hollow tube having a heat output end and a heat input end, the heat output end being positioned higher than the heat input end, the hollow tube containing a working fluid, the working fluid transferring heat from the heat input end to the heat output end, the working fluid being a liquid at a first temperature and a gas at a second temperature where the second temperature is greater than the first temperature, the working fluid becoming a gas as it is heated at the heat input end of the heat pipe, the working fluid rising upwards to the heat output end of the heat pipe, the working fluid becoming a liquid as the heat is transferred out of the heat pipe at the heat output end, the working fluid flowing back to the heat input end as a liquid;
the at least one heat pipe being positioned in the ground such that the heat input end is positioned adjacent a heat source;
an electricity generator being positioned adjacent the heat output end of the heat pipe such that heat from the heat output end is used to create electricity.

13. The system of claim 12 wherein the heat pipe is a sealed tubular shaft.

14. The system of claim 12 wherein the heat pipe is a coiled tube.

15. The system of claim 12 wherein the heat pipe is a vacuum sealed plasma drilled wellbore having a melted rock wall.

16. The system of claim 12 wherein the electricity generator is a steam chamber positioned adjacent the heat output end of the heat pipe, the steam chamber being heated by the heat pipe to create a steam, the steam running a turbine to create electricity.

17. The system of claim 12 wherein the electricity generator is a thermoelectric generator in which heat from the heat output is introduced to a hot side of the thermoelectric generator.

18. The system of claim 12 wherein at least two heat pipes are positioned in end to end relation with each other such that the heat input end of a first heat pipe is positioned adjacent a heat source, and the heat output end of the first heat pipe is adjacent the heat input end of a second heat pipe such that heat is transferred upwards between adjacent heat pipes.
